(19) United States
(12) Patent Application Publication
(10) Pub. No.: US 2003/0112459 A1
(43) Pub. Date: Jun. 19, 2003

(54) Document authenticity discriminating apparatus and method therefor

(76) Inventors: Masaki Yamada, Shiga (JP); Kinya Toda, Shiga (JP); Toshiya Hamasaki, Shiga (JP); Toru Fujii, Kyoto (JP)

Correspondence Address: DICKSTEIN SHAPIRO MORIN & OSHINSKY LLP, 2101 L STREET NW, WASHINGTON, DC, 20037-1526, US

(21) Appl. No.: 10/317,105

(22) Filed: Dec. 12, 2002

(30) Foreign Application Priority Data
Dec. 13, 2001 (JP) 2001-379374

(51) Int. Cl. B41F 1/00; G06F 15/00

(52) U.S. Cl. 358/1.14

(57) ABSTRACT

The present invention has its object to provide a document authenticity discriminating apparatus, in which authenticity can be discriminated with high accuracy at the time of discriminating authenticity of a presented document by acquiring picture images making use of a wavelength characteristic with respect to transmissivity and reflectance of light, and subjecting the acquired picture images to numeric conversion to find feature quantities, and a document authenticity discriminating method. The present invention is characterized by making use of a wavelength characteristic for a document with respect to transmissivity and reflectance of light, extracting feature quantities, in which wavelength characteristic is subjected to numeric conversion, on the basis of picture images of the document picked up by light sources having a plurality of wavelengths, and discriminating authenticity of the document from the feature quantities.

### FIELD OF THE INVENTION

The invention relates to a document authenticity discriminating apparatus for verifying and discriminating a document, and more particularly, to a document authenticity discriminating apparatus having a highly accurate discriminating function that can correctly read information to determine the genuine degree of a document in order to determine authenticity. A document authenticity discriminating method is also provided.

### BACKGROUND OF THE INVENTION

Generally, a document authenticity discriminating apparatus of this type is assembled into, for example, an automatic contracting machine to optically read, verify and discriminate contents of a document. Such documents presented by a user can include an identification card, or the like. In this case, when authenticity of a document is to be discriminated, the document is photographed by visible rays, and an operator inspects the photographed picture data to judge whether the document is genuine or false.

In recent years, however, with the technical progress of OA equipment, such documents are easily forged by means of high-performance instruments such as color duplicators or printers. With high-performance equipment, fraudulence is more likely to be committed because duplication can be made to the extent that there is no recognizable distinction between a genuine document and a forged document.

In order to prevent such fraudulence, there has been a demand for the development of document authenticity discriminating apparatuses with a highly accurate discriminating function. An example of conventional technology is a sheet-like item identifying apparatus (see, for example, JP-A-6-44437) which extracts feature data from grayscale pictures in full screen and reads every one of a plurality of light sources to make a comparison between a frequency distribution found from the feature data and a reference frequency distribution to identify a kind of and authenticity of a sheet-like item. In this conventional system, since the sheet-like item is identified from general picture data, identification is susceptible to influences of equipment and a sheet-like item and thus the accuracy and reliability of the data is decreased. Another disadvantage of the conventional system is that a large amount of data storage space is needed to save general verifying and discriminating data.

Another example of conventional technology is a document verifying apparatus (see, for example, JP-A-2001-76203) which photographs a document and using a plurality of kinds of light rays from various light sources having different wavelengths to make a comparison between the photographed picture image and a sample picture image to verify a genuine degree. In this case, there is a need of collecting many forged samples and analyzing them. Also, it is therefore necessary to have a large amount of data storage of sample picture images.

### SUMMARY OF THE INVENTION

An object of the invention is to provide a document authenticity discriminating apparatus, in which distinguishing between a genuine document and a false document can be performed with a high level of accuracy. Discriminating the authenticity of a presented document is provided by acquiring a picture image, and using wavelength characteristics with respect to transmissivity and reflectance of light, subjecting the acquired picture image to a numeric conversion to find a feature quantity. A document authenticity discriminating method is also provided.

The invention provides a document authenticity discriminating apparatus for discriminating authenticity of a document comprising a plural kinds of light sources having different wavelengths, pickup means for receiving at least one of transmitted light produced upon transmission of light from the plurality of light sources through the document and reflected light produced upon reflection of the light from the document to pick up the document. The invention further comprises calculating means for calculating feature quantities of a plurality of predetermined portions of the document being discriminated from pickup picture images picked up by the light source, storage means for storing feature functions for extraction of genuine degrees found from those reference feature quantities of a reference document, which are calculated by means of the calculating means, and genuine degree extracting means for extracting genuine degrees of the document being discriminated from the feature quantities of the document being discriminated and further calculated by the calculating means, and with the feature functions stored beforehand in the storage means.

A document, for exemplary purposes, can include any one of an identification card, a license, a certificate representative of particular information, or any other type of document needing verification. For exemplary purposes, the pickup means can be composed of an optical pickup equipment including CCD (charge coupled device) cameras or any other type of imager used for acquiring a picture image. The calculating means and the genuine degree extracting means can be composed of a calculating unit of a control system provided in the apparatus and provide calculation through a program incorporated into a RAM or the like, of a control circuit. The storage means can be composed of a hard disk or a storage device in place thereof, provided in the apparatus or a storage unit, such as a RAM or the like, provided in a control circuit.

The light source uses a plurality of monochromatic light rays, such as visible rays, infrared rays, and ultraviolet rays, having different wavelengths. Transmitted light produced when light from the light source is transmitted through a document, or reflected light produced when light from the light source is irradiated on a document to be reflected therefrom is picked up as picture data. A genuine certificate printed by, for example, an exclusive printing machine and a false certificate duplicated by OA equipment differ in transmissivity and reflectance of light due to differences in ink and quality of documents. These differences in feature portions can become considerably great when measured according to wavelength, due to the wavelength dependence of light. Picture data in those portions are used to find features with respect to transmissivity and reflectance, and such features are numerically converted to define feature quantities. The feature quantities, once numerically converted, can be represented by a probability that a genuine document can have particular feature quantities. Feature functions are representative of a correspondence to the probability, which is defined as a genuine degree.

Data of reference feature quantities of a genuine document are analyzed beforehand to be stored. The feature functions present data for calculation of a genuine degree. In setting the genuine degree, respective genuine degrees are found from feature functions, which in turn are found from reference feature quantities. Every one of a plurality of portions on a genuine document and a numeric value obtained by multiplying all the genuine degrees together can be made a final genuine degree of the document.

The genuine degree found through numeric conversion approaches “1” with a genuine document and “0” with a false document whenever numerical values are multiplied together in the course of extraction, and so it is possible to correctly discriminate authenticity on the basis of such results of numerical values. The more feature quantities are set for portions, the higher accuracy and reliability obtained for data in discriminating authenticity. Feature functions are found only from data of a genuine document and unlike existing discriminating techniques that need many false samples and analysis thereof, it is possible according to the present invention to readily build the authenticity discriminating function.

Since arithmetic processing can be realized using a statistical technique in which genuine degrees are found from pickup picture images of many genuine documents, feature functions are determined from a distribution of the feature quantities of the genuine documents, and genuine degrees are found from the plurality of feature functions thus determined. Therefore, it is possible to correctly discriminate authenticity of a document under less influence of dispersion in equipment and documents.

The amount of feature functions data being stored in this case is also markedly smaller than that of sample picture images used in conventional discriminating techniques. The discriminating performance can be further enhanced by increasing kinds of light sources. New feature quantities can be found from picture images acquired with the use of additional light sources and feature functions, and since feature functions are independent of one another, existing feature functions can be used effectively as they are. Therefore, extendibility is facilitated because feature functions can be utilized only by multiplication of numerical values. Accordingly, labor is not required to find feature quantities and reference data should. Independent feature functions can be combined in different patterns, and so it is possible to set various discriminating standards.

The feature quantities are grasped from picture images picked up by pickup means, and determined from distribution functions of average values of luminance in a photograph portion or particular portions of characters, for example in a license, but not found from a luminance distribution in a whole display surface of a license, so that the above effect is produced.

Additional advantages and features of the present invention will be apparent from the following detailed description and drawings which illustrate preferred embodiments of the invention.

### BRIEF DESCRIPTION OF THE DRAWINGS

FIG. 1 is a perspective view showing an outward appearance of a document authenticity discriminating apparatus according to the invention.

FIG. 2 is a schematic, configurational view showing the document authenticity discriminating apparatus according to the invention.

FIG. 3 is a schematic, plan view showing a license used in the document authenticity discriminating apparatus according to the invention.

FIG. 4 is a flowchart illustrating an operation of picture image taking-in processing in the document authenticity discriminating apparatus according to the invention.

FIG. 5 is an illustration showing configurational examples of feature functions with infrared rays in the invention.

FIG. 6 is a flowchart illustrating an operation of authenticity discriminating processing in plural kinds of light sources having different wavelengths according to the present invention.

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized, and that structural, logical and electrical changes may be made without departing from the spirit and scope of the present invention. Additionally, processing steps described and their progression are exemplary of preferred embodiments of the invention; however, the sequence of steps is not limited to that set forth herein and may be changed as is known in the art, with the exception of steps necessarily occurring in a certain order.

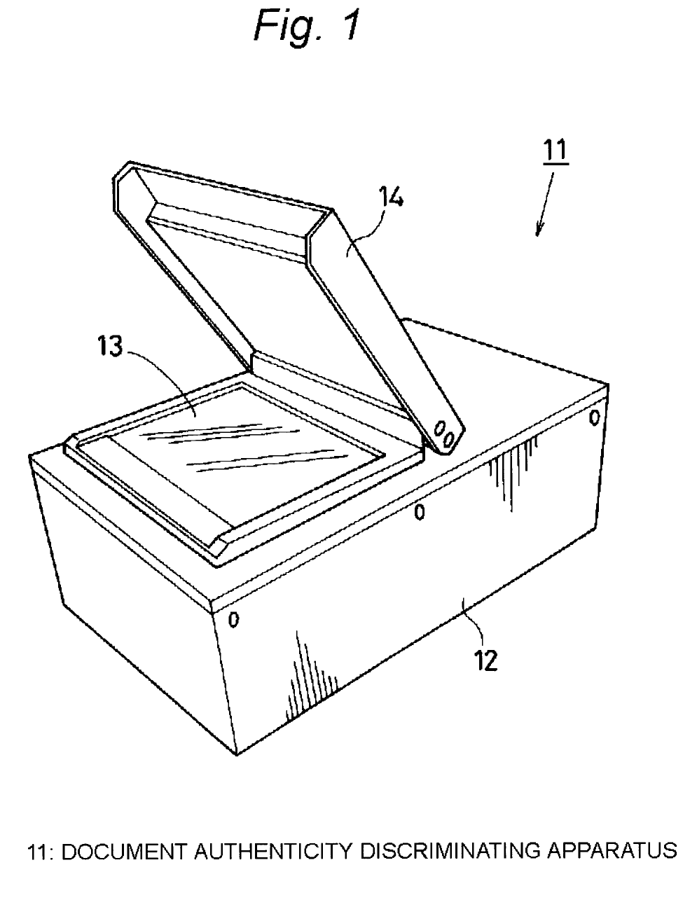

An explanation will be given below in detail to embodiments of the invention with reference to the drawings. The drawings show a document authenticity discriminating apparatus for discriminating authenticity of a document such as a drivers license or other documents in need of authentication. FIG. 1 shows the document authenticity discriminating apparatus 11, comprising a surface 13 on an upper surface of a rectangular apparatus body 12, on which surface a document, for exemplary purposes, a drivers license (referred below to as a license) is placed, and a single swing type movable door 14 provided on the upper surface.

Surface 13 acquires a picture image by optically detecting display data with the use of transmitted light and reflected light to discriminate authenticity of a license. In order to acquire the picture image, a planar glass surface is provided and a surface of the license is placed thereon with the front surface facing downward, and a portion of the surface is set in a picture image acquiring position.

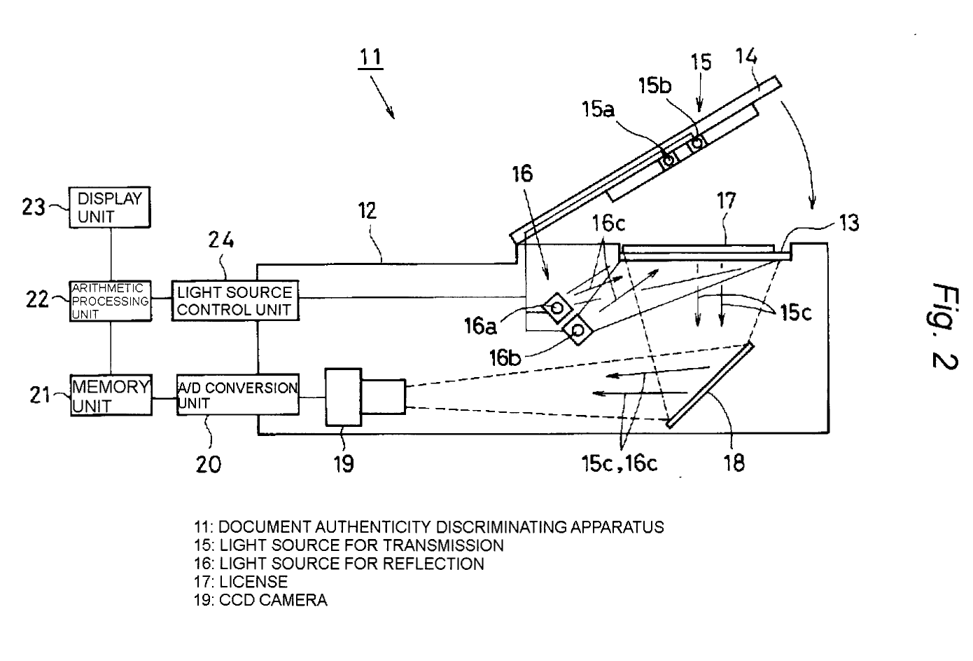

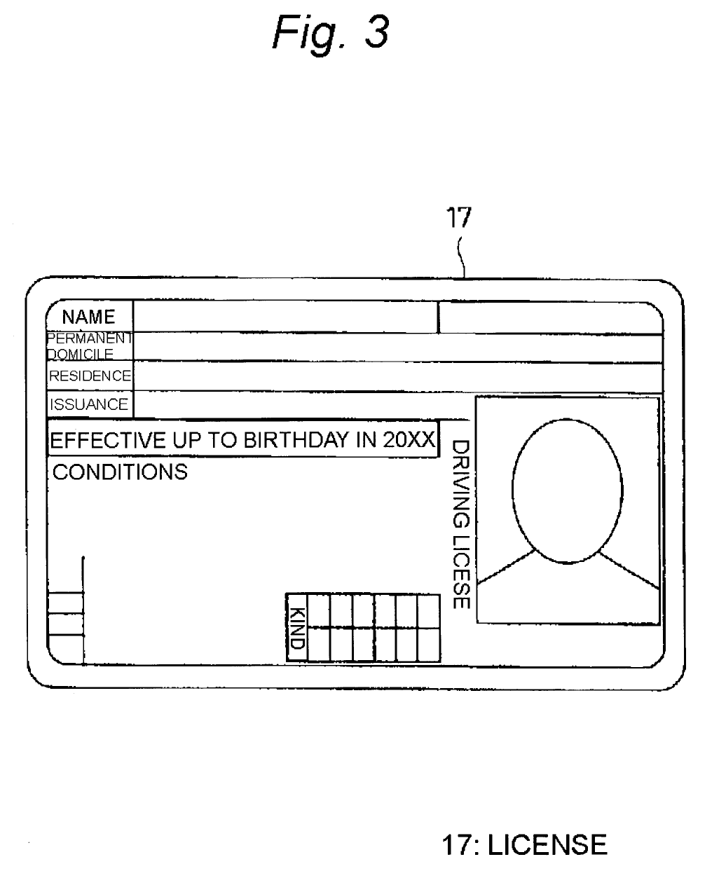

FIG. 2 shows an exemplary internal construction of a document authenticity discriminating apparatus 11 having the picture image acquiring function. The document authenticity discriminating apparatus 11, uses a light source 15 for transmission which is positioned on an underside of the movable door 14 and a light source 16 for reflection positioned inside of the apparatus body 12. Light from both of the light sources 15, 16 is conducted to the surface 13 and a picture image of a license 17 set on the surface 13 in a planar manner as shown in FIG. 3 is partially acquired.

Two types of light emitting diodes 15a, 15b having different wavelengths are used for the light source 15 for transmission. Light emitting diode 15a is for visible rays and light emitting diode 15b is for infrared rays. At the time of transmission, transmitted light 15c is transmitted directly below from the movable door 14 to be directed toward a front side of the license 17 placed on the surface 13 from a back side thereof. The transmitted light 15c, transmitted directly below from the license 17 strikes against a reflecting mirror 18 arranged obliquely below the license to be refracted in a horizontal direction from a vertical direction to be changed in a substantially horizontal direction to be conducted to a CCD camera 19 laterally opposed to the mirror. A transmitted picture image through the license 17 is thus acquired.

The light source 16 uses two kinds of light emitting diodes 16a, 16b having different wavelengths for reflection. Light emitting diode 16a is for visible rays and light emitting diode 16b is for infrared rays. At the time of reflection, the reflected light 16c is irradiated from obliquely downward to be directed toward the front side of the license 17 placed on the surface 13. The irradiated light, irradiated obliquely upward on the license 17, from obliquely downward, strikes against the downwardly facing display surface of the license 17 to be reflected substantially directly below. The reflected light 16c strikes against the reflecting mirror 18 arranged obliquely in a lower position to be refracted in a horizontal direction from a vertical direction to be changed in a substantially horizontal direction to be conducted to the CCD camera 19 laterally opposed to the mirror. Thus a reflected picture image reflected from the license 17 is acquired.

A picture signal acquired by the CCD camera 19 is converted into digital data by an A/D (analog/digital) conversion unit 20 and to be stored as picture data in a memory unit 21. The picture data is subjected to arithmetic processing in an arithmetic processing unit 22, and then results of arithmetic processing are displayed on a display unit 23. A light source control unit 24, used to perform control of picture acquisition and quantity of light for the light sources 15, 16 is connected to the arithmetic processing unit 22.

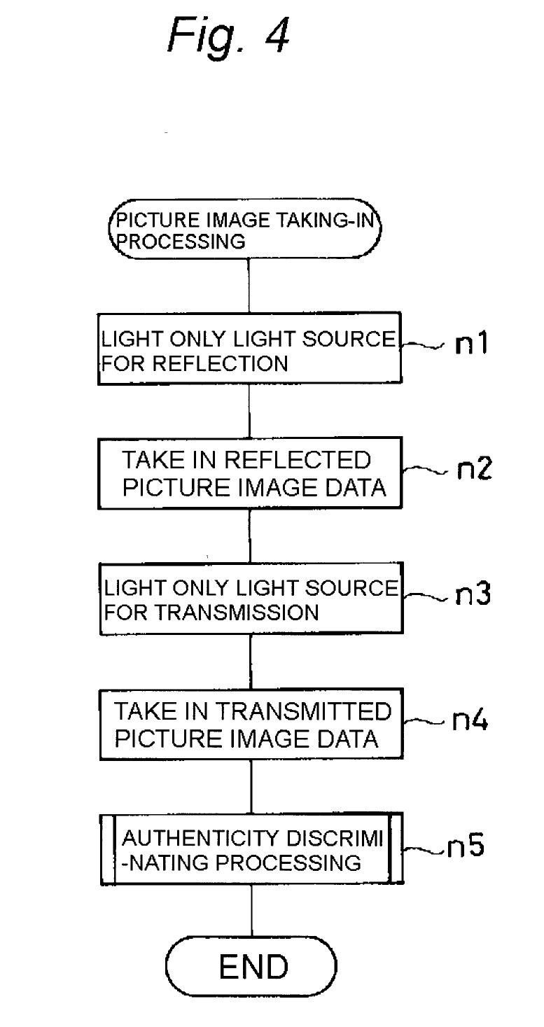

An explanation will be given below to a picture acquiring operation of the document authenticity discriminating apparatus 11 constructed in the above manner with reference to the flowchart shown in FIG. 4. First, setting by a user is completed by opening the movable door 14 of the document authenticity discriminating apparatus 11, setting the license 17 in a predetermined position on the surface 13 with a photograph surface (front surface) side facing downward, and thereafter closing the movable door 14. After the completion of such setting, when a picture acquisition signal is input, the light source control unit 24 lights only the light source 16 for reflection to permit the CCD camera 19 to acquire a reflected picture image produced by the reflected light 16c reflected on the license 17 (STEPs n1 to n2).

Subsequent to acquisition of the reflected picture image, the light source control unit 24 lights only the light source 15 for transmission to transmit light through the license 17 from above the surface 13. A transmitted picture image produced by the transmitted light 15c is acquired by the CCD camera 19 (STEPs n3 to n4). After acquisition of the picture image, the arithmetic processing unit 22 discriminates authenticity to determine whether the license is a genuine document or a false document. The results are displayed on the display unit 23 (STEP n5).

At the time of discriminating authenticity, a feature quantity for discriminating authenticity can be determined by acquiring as picture data the transmitted light produced when light from the light source is transmitted through the license 17, or the reflected light produced when light from the light source is reflected from the license 17. A genuine license 17 printed by an exclusive printing machine and a false license duplicated by an OA equipment differ in transmissivity and reflectance of light due to differences in ink and quality of documents. Such differences are obvious in portions where the differences according to wavelength between a genuine document and a false document are great, due to the wavelength dependence of light. Picture data from such portions are used to determine features with respect to transmissivity and reflectance, and such features are determined and numerically converted to define feature quantities. The feature quantities, once numerically converted, can be represented by a probability that a genuine document can have particular feature quantities. Feature functions are representative of a correspondence to the probability, which is defined as a genuine degree.

The feature functions present data for calculation of a genuine degree. Data of reference feature quantities of a genuine document are analyzed beforehand to be stored. The feature functions present data for calculation of a genuine degree. In setting the genuine degree, respective genuine degrees are found from feature functions, which in turn are found from reference feature quantities. Every one of a plurality of portions on a genuine document (photograph portion, character portion, boundary portion, or the like) and a numeric value obtained by multiplying all the genuine degrees together can be made a final genuine degree of the document, indicated on a genuine license 17 in FIG. 3. A numeric value obtained by multiplying all the genuine degrees together can be made a final genuine degree of the license 17.

The genuine degree found through numeric conversion approaches “1” with a genuine document and “0” with a false document whenever numerical values are multiplied together in the course of extraction, and so it is possible to correctly discriminate authenticity on the basis of such results of numerical values. As reference feature quantities are set for many portions, data for discriminating authenticity is enhanced in accuracy to provide discriminated results of high reliability and accuracy. Feature functions are found only from data of a genuine license 17 and there is no need for numerous false samples and analysis thereof as in conventional discriminating technology, so that it is possible to readily build the authenticity discriminating function according to the present invention.

An explanation will be given of the arithmetic processing when authenticity of a license 17 is discriminated. Data providing the basis for such authenticity discriminating processing comprise reflected picture images and transmitted picture images acquired by the CCD camera 19. Feature quantities for portions in which a genuine document and a false document are different are extracted from these picture images and used for processing. For example, when infrared rays are used in the light source 16 for reflection, concentration differences are in some cases generated as compared with visible rays, so that it is possible to select an average value of luminance in a photograph portion as a feature quantity. And the relationship of a genuine degree with such feature quantity is beforehand found as a feature function.

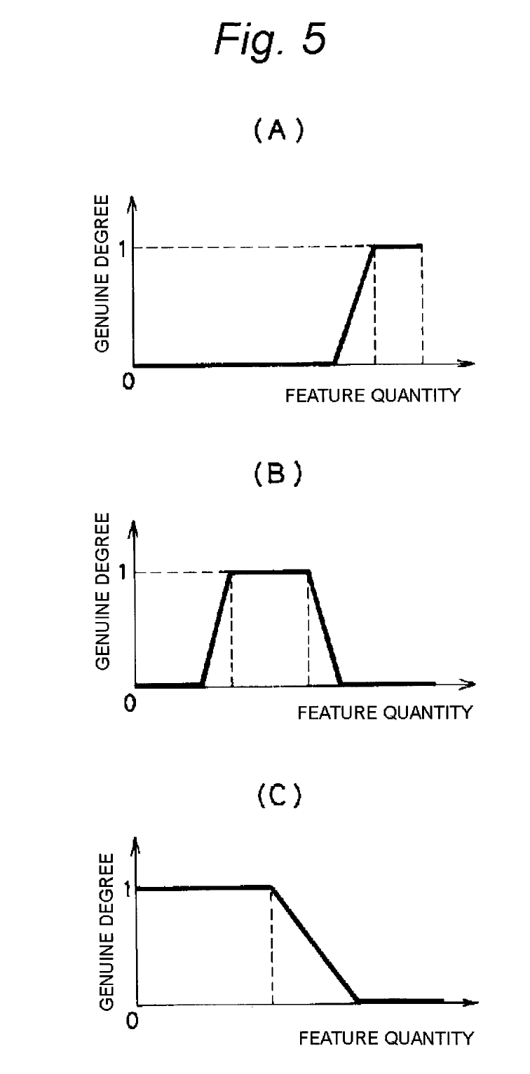

FIG. 5 shows examples representing typical feature functions in graph form. The feature functions can be experimentally found by acquiring data of reference feature quantities of a genuine document. For example, in the case where a feature quantity is given by an average value of luminance in a photograph portion of a reflected picture image acquired with the use of infrared rays, a feature function assumes a configuration in which a genuine degree is increased in proportion to an increase in the feature quantity, as shown in FIG. 5A. In the case where a feature quantity is given by an average value of luminance in a certain region in a transmitted picture image, a feature function assumes a configuration in which a genuine degree with high accuracy is obtained even when the feature quantity is not large, as shown in FIG. 5B. In the case where a feature quantity is given by an average value of luminance in a character portion of a reflected picture image acquired with the use of, for example, infrared rays, a feature function assumes a configuration in which a genuine degree with high accuracy is obtained even when the feature quantity is small, as shown in FIG. 5(C).

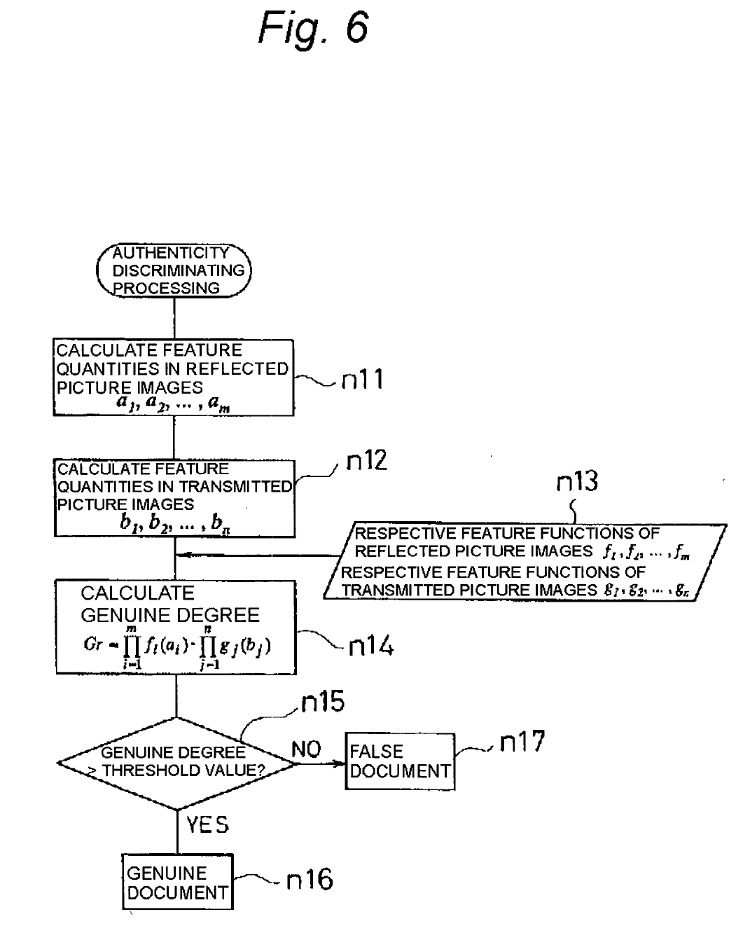

A way to calculate a genuine degree from feature functions is illustrated as follows. An explanation will be given to an authenticity discriminating operation with calculation of a genuine degree with reference to a flowchart shown in FIG. 6. In the arithmetic processing unit 22, a1, a2, . . . , am denote feature quantities in reflected picture images photographed by a reflected light, such as infrared rays, visible rays, or the like, from a plurality of light sources having different wavelengths. As shown in FIG. 6, f1, f2, . . . , fm denote feature functions corresponding to the respective feature quantities at that time (STEP n11). Further shown in FIG. 6, b1, b2, . . . , bn denote feature quantities in transmitted picture images photographed by a transmitted light, such as infrared rays, visible rays, or the like, from a plurality of light sources having different wavelengths, and g1, g2, . . . , gn denote feature functions corresponding to the respective feature quantities at that time (STEP n12).

Genuine degrees for the respective feature quantities of reflected picture images can be represented by f1 (a1) , f2 (a2) , . . . , fm(am), and genuine degrees for the respective feature quantities of transmitted picture images can be represented by g1(b1), g2(b2), . . . , gn(bn) (STEP n13). As a result, a final genuine degree Gr of the license 17 can be defined as a product of these genuine degrees as shown in the following formula 1, below (STEP n14).

$$Gr = {\prod }_{j = 1}^{m} {f}_{j} ( {a}_{j} ) \cdot {\prod }_{j = 1}^{n} {g}_{j} ( {b}_{j} )$$

{=f₁(a₁)×f₂(a₂)× . . . ×fₘ(aₘ)×g₁(b₁)×g₂(b₂) . . . ×gₙ(bₙ)}

In addition, a genuine degree of the license 17 may be discriminated by means of monochromatic light and may be discriminated by means of plural kinds of light sources having different wavelengths.

Since the genuine degree Gr becomes “1” with a genuine document and “0” with a false document, a certain threshold value is set (STEP n15) and the threshold value as set is used to discriminate authenticity. When the genuine degree is greater than the threshold value, the license can be judged to be genuine (STEP n16) and when not so, the license can be judged to be false (STEP n17). As an alternative to setting such a threshold value, a genuine degree may be displayed as a result and an operator may discriminate authenticity on the basis of the resultant value.

Formula 1 shows a genuine degree for each of feature quantities is completely independent from the other genuine degrees, and the respective genuine degrees are on a level with one another. Therefore, there is an advantage of excellent extendibility. As an example, when increasing a feature quantity with a view to enhancement in the discriminating performance, a genuine degree can be found by determining only a feature function for the feature quantity and performing a new multiplication thereof. As shown above, duplication of a license or other document, by means of a duplicator, a scanner, or a genuine license or document to which characters or a photograph is applied, can be determined to be false.

As described above, feature quantities are determined from picture images of a genuine document as picked up, and feature functions are determined from distributions of the feature quantities of the genuine document. Since, an arithmetic processing can be done using the described statistical technique, in which genuine degrees are determined from the plurality of feature functions thus determined, it is possible to correctly discriminate authenticity of a license or other document under less influence of dispersion in equipment and documents. According to the invention, feature functions capable of discriminating authenticity with high accuracy are determined, whereby it is possible to stably discriminate authenticity with high reliability.

While the invention has been described and illustrated with reference to specific exemplary embodiments, it should be understood that many modifications and substitutions could be made without departing from the spirit and scope of the invention. Accordingly, the invention is not to be considered limited by the foregoing description but is only limited by the scope of the appended claims.

What is claimed as new and desired to be protected by Letters Patent of the United States is:

1. A document authenticity discriminating apparatus for discriminating authenticity of a document, comprising
plural kinds of light sources having different wavelengths;
pickup means for receiving at least one of transmitted light produced upon transmission of light from the plural kinds of light sources through the document and reflected light produced upon reflection of the light from the document to pick up the document;
calculating means for calculating feature quantities of a plurality of predetermined portions of the document being discriminated, from pickup picture images picked up by light source with the use of the pickup means;
storage means for storing feature functions for extraction of genuine degrees found from those reference feature quantities of a reference document, which are calculated by means of the calculating means; and
genuine degree extracting means for extracting genuine degrees of the document being discriminated, from the feature quantities of the document being discriminated, calculated by the calculating means, and the feature functions stored beforehand in the storage means.

2. The document authenticity discriminating apparatus according to claim 1, wherein the feature functions are constituted by summing up distributions of reference feature quantities found from a plurality of different reference documents.

3. The document authenticity discriminating apparatus according to claim 1, further comprising output means for comparing those genuine degrees, which are calculated from the feature quantities of the document being discriminated and the feature functions stored beforehand, with threshold values set from the reference feature quantities stored beforehand in the storage means to output authenticity discriminating results found by such comparison.

4. The document authenticity discriminating apparatus according to claim 1, wherein said genuine degree extracting means is calculated according to the formula:
$$Gr = {\prod }_{j = 1}^{m} {f}_{j} ( {a}_{j} ) \cdot {\prod }_{j = 1}^{n} {g}_{j} ( {b}_{j} )$$
{=f₁(a₁)×f₂(a₂)× . . . ×fₘ(aₘ)×g₁(b₁)×g₂(b₂) . . . ×gₙ(bₙ)}

5. The document authenticity discriminating apparatus according to claim 1, wherein in said plural kinds of light sources include at least one of an infrared light source, an ultraviolet light source and a visible light source.

6. The document authenticity discriminating apparatus according to claim 1, wherein said numeric conversion approaches “1” with a genuine document and “0” with a false document.

7. The document authenticity discriminating apparatus according to claim 1, wherein said pickup means is an imager used for acquiring a picture image.

8. A document authenticity discriminating apparatus for discriminating authenticity of a document, comprising
plural kinds of light sources having different wavelengths;
pickup means for receiving both transmitted light produced upon transmission of light from the plural kinds of light sources through the document and reflected light produced upon reflection of the light from the document to pick up the document;
calculating means for calculating feature quantities of a plurality of predetermined portions of the document being discriminated, from pickup picture images picked up by light source with the use of the pickup means;
storage means for storing feature functions for extraction of genuine degrees. found from those reference feature quantities of a reference document, which are calculated by means of the calculating means; and
genuine degree extracting means for performing numeric conversion and calculation of genuine degrees by light source from the feature quantities of the document being discriminated, calculated by the calculating means, and the feature functions stored beforehand in the storage means, and multiplying the calculated genuine degrees to extract genuine degrees.

9. The document authenticity discriminating apparatus according to claim 8, wherein the feature functions are constituted by summing up distributions of reference feature quantities found from a plurality of different reference documents.

10. The document authenticity discriminating apparatus according to claim 8, further comprising output means for comparing those genuine degrees, which are calculated from the feature quantities of the document being discriminated and the feature functions stored beforehand, with threshold values set from the reference feature quantities stored beforehand in the storage means to output authenticity discriminating results found by such comparison.

11. The document authenticity discriminating apparatus according to claim 8, wherein said genuine degree extracting means is calculated according to the formula:
$$Gr = {\prod }_{j = 1}^{m} {f}_{j} ( {a}_{j} ) \cdot {\prod }_{j = 1}^{n} {g}_{j} ( {b}_{j} )$$
{=f₁(a₁)×f₂(a₂)× . . . ×fₘ(aₘ)×g₁(b₁)×g₂(b₂) . . . ×gₙ(bₙ)}

12. The document authenticity discriminating apparatus according to claim 8, wherein in said plural kinds of light sources include at least one of an infrared light source and a visible light source.

13. The document authenticity discriminating apparatus according to claim 8, wherein said numeric conversion approaches “1” with a genuine document and “0” with a false document.

14. The document authenticity discriminating apparatus according to claim 8, wherein said pickup means is an imager used for acquiring a picture image.

15. A method of discriminating authenticity of a document, comprising
transmitting or reflecting plural kinds of light sources having different wavelengths on to a document to be authenticated;
receiving at least one of the transmitted light produced upon transmission of light from the plural kinds of light sources through the document and the reflected light produced upon reflection of the light from the document to pick up the document using a pickup means;
calculating feature quantities of a plurality of predetermined portions of the document being discriminated, from images picked up by the light source in the pickup step;
storing feature functions for extraction of genuine degrees found from those reference feature quantities of a reference document, which are calculated in the calculating step; and
extracting genuine degrees of the document being discriminated, from the feature quantities of the document being discriminated, calculated in the calculating step, and the feature functions stored beforehand in the storage step.

16. A method of discriminating authenticity of a document, comprising
transmitting or reflecting plural kinds of light sources having different wavelengths;
receiving both transmitted light produced upon transmission of light from the plural kinds of light sources through the document and reflected light produced upon reflection of the light from the document to pick up the document using a pickup means;
calculating feature quantities of a plurality of predetermined portions of the document being discriminated, from pickup picture images picked up by light source in the pickup step;
storing feature functions for extraction of genuine degrees found from those reference feature quantities of a reference document, which are calculated the calculating step; and
performing numeric conversion and calculation of genuine degrees by light source from the feature quantities of the document being discriminated, calculated in the calculating step, and the feature functions stored beforehand in the storage step, and multiplying the calculated genuine degrees to extract genuine degrees of the document being discriminated.
